(19) United States
(12) Patent Application Publication
(10) Pub. No.: US 2017/0123706 A1
(43) Pub. Date: May 4, 2017

(54) GROUPING DS UNITS IN AN AD-HOC AND HETEROGENEOUS NETWORK TO MAXIMIZE FAILURE INDEPENDENCE

(71) Applicant: International Business Machines Corporation, Armonk, NY (US)

(72) Inventors: Teague S. Algie, Chicago, IL (US); Jason K. Resch, Chicago, IL (US)

(21) Appl. No.: 15/408,035

(22) Filed: Jan. 17, 2017

Related U.S. Application Data
(63) Continuation-in-part of application No. 15/082,887, filed on Mar. 28, 2016.
(60) Provisional application No. 62/168,145, filed on May 29, 2015.

(51) Int. Cl. G06F 3/06; G06F 11/10

(52) U.S. Cl. CPC G06F 3/0631; G06F 3/0619; G06F 3/064; G06F 3/067; G06F 11/1076; G06F 3/0604

(57) ABSTRACT

A method for use in a distributed storage network (DSN) including a plurality of distributed storage (DS) units includes determining to create a new storage pool that includes a set of storage groups, which in turn include one or more memory sections. The memory sections include one or more DS units. Memory information is obtained for the DS units, and the DS units are stratified based on available memory capacity. A DSN address range of the new storage pool is mapped to one or more sub-DSN address ranges for the memory sections based on a level of available storage capacity of the new storage pool. For each of the memory sections, particular DS units are selected in accordance with a memory selection scheme using the memory information. Configuration information identifying the DS units selected for inclusion in particular memory sections is issued to the DS units.

### CROSS-REFERENCE TO RELATED APPLICATIONS

The present U.S. Utility Patent Application claims priority pursuant to 35 U. S.C. §120 as a continuation-in-part of U.S. Utility application Ser. No. 15/082,887, entitled “TRANSFERRING ENCODED DATA SLICES IN A DISPERSED STORAGE NETWORK,” filed Mar. 28, 2016, which claims priority pursuant to 35 U.S.C. §119(e) to U.S. Provisional Application No. 62/168,145, entitled “TRANSFERRING ENCODED DATA SLICES BETWEEN STORAGE RESOURCES,” filed May 29, 2015, both of which are hereby incorporated herein by reference in their entirety and made part of the present U.S. Utility Patent Application for all purposes.

### STATEMENT REGARDING FEDERALLY SPONSORED RESEARCH OR DEVELOPMENT

Not applicable.

### INCORPORATION-BY-REFERENCE OF MATERIAL SUBMITTED ON A COMPACT DISC

Not applicable.

### BACKGROUND OF THE INVENTION

Technical Field of the Invention

This invention relates generally to computer networks and more particularly to dispersing error encoded data.

Description of Related Art

Computing devices are known to communicate data, process data, and/or store data. Such computing devices range from wireless smart phones, laptops, tablets, personal computers (PC), work stations, and video game devices, to data centers that support millions of web searches, stock trades, or on-line purchases every day. In general, a computing device includes a central processing unit (CPU), a memory system, user input/output interfaces, peripheral device interfaces, and an interconnecting bus structure.

As is further known, a computer may effectively extend its CPU by using “cloud computing” to perform one or more computing functions (e.g., a service, an application, an algorithm, an arithmetic logic function, etc.) on behalf of the computer. Further, for large services, applications, and/or functions, cloud computing may be performed by multiple cloud computing resources in a distributed manner to improve the response time for completion of the service, application, and/or function. For example, Hadoop is an open source software framework that supports distributed applications enabling application execution by thousands of computers.

In addition to cloud computing, a computer may use “cloud storage” as part of its memory system. As is known, cloud storage enables a user, via its computer, to store files, applications, etc. on an Internet storage system. The Internet storage system may include a RAID (redundant array of independent disks) system and/or a dispersed storage system that uses an error correction scheme to encode data for storage.

In some cases, conventional dispersed storage systems can be vulnerable to network outages. Additionally, some conventional storage systems may have difficulty if physical storage units used in a single storage pool have vastly different storage capacities.

### BRIEF DESCRIPTION OF THE SEVERAL VIEWS OF THE DRAWING(S)

FIG. 1 is a schematic block diagram of an embodiment of a dispersed or distributed storage network (DSN) in accordance with the present invention;

FIG. 2 is a schematic block diagram of an embodiment of a computing core in accordance with the present invention;

FIG. 3 is a schematic block diagram of an example of dispersed storage error encoding of data in accordance with the present invention;

FIG. 4 is a schematic block diagram of a generic example of an error encoding function in accordance with the present invention;

FIG. 5 is a schematic block diagram of a specific example of an error encoding function in accordance with the present invention;

FIG. 6 is a schematic block diagram of an example of a slice name of an encoded data slice (EDS) in accordance with the present invention;

FIG. 7 is a schematic block diagram of an example of dispersed storage error decoding of data in accordance with the present invention;

FIG. 8 is a schematic block diagram of a generic example of an error decoding function in accordance with the present invention;

FIG. 9 is a schematic block diagram of an embodiment of a distributed computing system in accordance with the present invention; and

FIG. 10 is a flowchart illustrating an example of selecting memories to form a storage pool in accordance with the present invention.

### DETAILED DESCRIPTION OF THE INVENTION

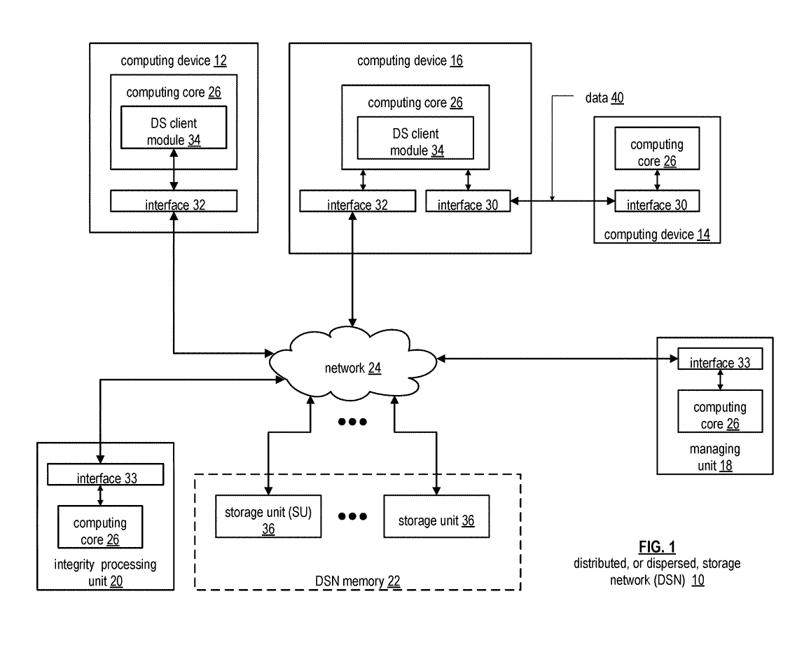

FIG. 1 is a schematic block diagram of an embodiment of a dispersed, or distributed, storage network (DSN) 10 that includes a plurality of computing devices 12-16, a managing unit 18, an integrity processing unit 20, and a DSN memory 22. The components of the DSN 10 are coupled to a network 24, which may include one or more wireless and/or wire lined communication systems; one or more non-public intranet systems and/or public internet systems; and/or one or more local area networks (LAN) and/or wide area networks (WAN).

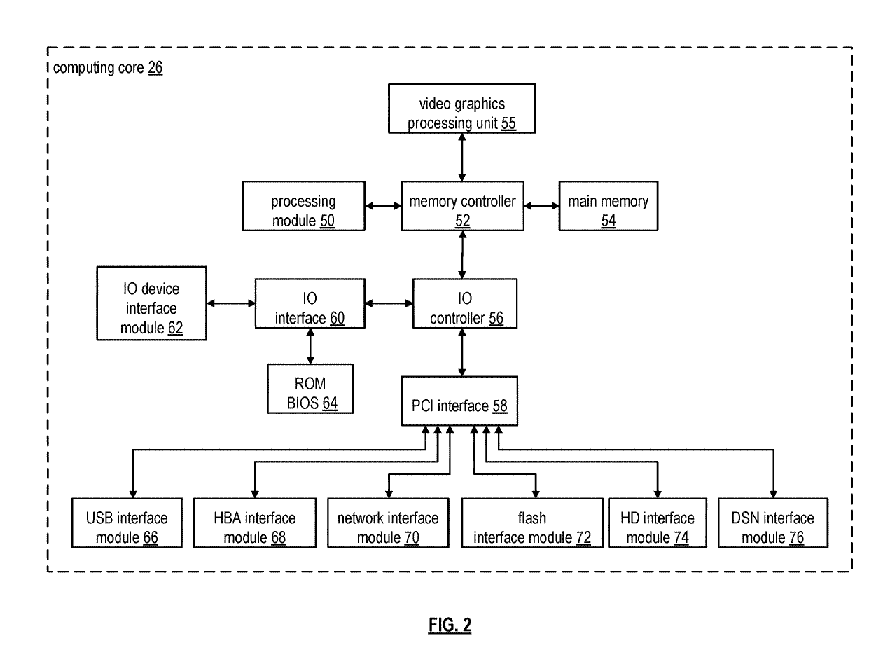

The DSN memory 22 includes a plurality of storage units 36 that may be located at geographically different sites (e.g., one in Chicago, one in Milwaukee, etc.), at a common site, or a combination thereof. For example, if the DSN memory 22 includes eight storage units 36, each storage unit is located at a different site. As another example, if the DSN memory 22 includes eight storage units 36, all eight storage units are located at the same site. As yet another example, if the DSN memory 22 includes eight storage units 36, a first pair of storage units are at a first common site, a second pair of storage units are at a second common site, a third pair of storage units are at a third common site, and a fourth pair of storage units are at a fourth common site. Note that a DSN memory 22 may include more or less than eight storage units 36. Further note that each storage unit 36 includes a computing core (as shown in FIG. 2, or components thereof) and a plurality of memory devices for storing dispersed error encoded data.

Each of the computing devices 12-16, the managing unit 18, and the integrity processing unit 20 include a computing core 26, which includes network interfaces 30-33. Computing devices 12-16 may each be a portable computing device and/or a fixed computing device. A portable computing device may be a social networking device, a gaming device, a cell phone, a smart phone, a digital assistant, a digital music player, a digital video player, a laptop computer, a handheld computer, a tablet, a video game controller, and/or any other portable device that includes a computing core. A fixed computing device may be a computer (PC), a computer server, a cable set-top box, a satellite receiver, a television set, a printer, a fax machine, home entertainment equipment, a video game console, and/or any type of home or office computing equipment. Note that each of the managing unit 18 and the integrity processing unit 20 may be separate computing devices, may be a common computing device, and/or may be integrated into one or more of the computing devices 12-16 and/or into one or more of the storage units 36.

Each interface 30, 32, and 33 includes software and hardware to support one or more communication links via the network 24 indirectly and/or directly. For example, interface 30 supports a communication link (e.g., wired, wireless, direct, via a LAN, via the network 24, etc.) between computing devices 14 and 16. As another example, interface 32 supports communication links (e.g., a wired connection, a wireless connection, a LAN connection, and/or any other type of connection to/from the network 24) between computing devices 12 and 16 and the DSN memory 22. As yet another example, interface 33 supports a communication link for each of the managing unit 18 and the integrity processing unit 20 to the network 24.

Computing devices 12 and 16 include a dispersed storage (DS) client module 34, which enables the computing device to dispersed storage error encode and decode data (e.g., data 40) as subsequently described with reference to one or more of FIGS. 3-8. In this example embodiment, computing device 16 functions as a dispersed storage processing agent for computing device 14. In this role, computing device 16 dispersed storage error encodes and decodes data on behalf of computing device 14. With the use of dispersed storage error encoding and decoding, the DSN 10 is tolerant of a significant number of storage unit failures (the number of failures is based on parameters of the dispersed storage error encoding function) without loss of data and without the need for a redundant or backup copies of the data. Further, the DSN 10 stores data for an indefinite period of time without data loss and in a secure manner (e.g., the system is very resistant to unauthorized attempts at accessing the data).

In operation, the managing unit 18 performs DS management services. For example, the managing unit 18 establishes distributed data storage parameters (e.g., vault creation, distributed storage parameters, security parameters, billing information, user profile information, etc.) for computing devices 12-14 individually or as part of a group of user devices. As a specific example, the managing unit 18 coordinates creation of a vault (e.g., a virtual memory block associated with a portion of an overall namespace of the DSN) within the DSN memory 22 for a user device, a group of devices, or for public access and establishes per vault dispersed storage (DS) error encoding parameters for a vault. The managing unit 18 facilitates storage of DS error encoding parameters for each vault by updating registry information of the DSN 10, where the registry information may be stored in the DSN memory 22, a computing device 12-16, the managing unit 18, and/or the integrity processing unit 20.

The managing unit 18 creates and stores user profile information (e.g., an access control list (ACL)) in local memory and/or within memory of the DSN memory 22. The user profile information includes authentication information, permissions, and/or the security parameters. The security parameters may include encryption/decryption scheme, one or more encryption keys, key generation scheme, and/or data encoding/decoding scheme.

The managing unit 18 creates billing information for a particular user, a user group, a vault access, public vault access, etc. For instance, the managing unit 18 tracks the number of times a user accesses a non-public vault and/or public vaults, which can be used to generate a per-access billing information. In another instance, the managing unit 18 tracks the amount of data stored and/or retrieved by a user device and/or a user group, which can be used to generate a per-data-amount billing information.

As another example, the managing unit 18 performs network operations, network administration, and/or network maintenance. Network operations includes authenticating user data allocation requests (e.g., read and/or write requests), managing creation of vaults, establishing authentication credentials for user devices, adding/deleting components (e.g., user devices, storage units, and/or computing devices with a DS client module 34) to/from the DSN 10, and/or establishing authentication credentials for the storage units 36. Network administration includes monitoring devices and/or units for failures, maintaining vault information, determining device and/or unit activation status, determining device and/or unit loading, and/or determining any other system level operation that affects the performance level of the DSN 10. Network maintenance includes facilitating replacing, upgrading, repairing, and/or expanding a device and/or unit of the DSN 10.

The integrity processing unit 20 performs rebuilding of ‘bad’ or missing encoded data slices. At a high level, the integrity processing unit 20 performs rebuilding by periodically attempting to retrieve/list encoded data slices, and/or slice names of the encoded data slices, from the DSN memory 22. For retrieved encoded slices, they are checked for errors due to data corruption, outdated version, etc. If a slice includes an error, it is flagged as a ‘bad’ slice. For encoded data slices that were not received and/or not listed, they are flagged as missing slices. Bad and/or missing slices are subsequently rebuilt using other retrieved encoded data slices that are deemed to be good slices to produce rebuilt slices. The rebuilt slices are stored in the DSN memory 22.

FIG. 2 is a schematic block diagram of an embodiment of a computing core 26 that includes a processing module 50, a memory controller 52, main memory 54, a video graphics processing unit 55, an input/output (IO) controller 56, a peripheral component interconnect (PCI) interface 58, an IO interface module 60, at least one IO device interface module 62, a read only memory (ROM) basic input output system (BIOS) 64, and one or more memory interface modules. The one or more memory interface module(s) includes one or more of a universal serial bus (USB) interface module 66, a host bus adapter (HBA) interface module 68, a network interface module 70, a flash interface module 72, a hard drive interface module 74, and a DSN interface module 76.

The DSN interface module 76 functions to mimic a conventional operating system (OS) file system interface (e.g., network file system (NFS), flash file system (FFS), disk file system (DFS), file transfer protocol (FTP), web-based distributed authoring and versioning (WebDAV), etc.) and/or a block memory interface (e.g., small computer system interface (SCSI), internet small computer system interface (iSCSI), etc.). The DSN interface module 76 and/or the network interface module 70 may function as one or more of the interface 30-33 of FIG. 1. Note that the IO device interface module 62 and/or the memory interface modules 66-76 may be collectively or individually referred to as IO ports.

FIG. 3 is a schematic block diagram of an example of dispersed storage error encoding of data. When a computing device 12 or 16 has data to store it disperse storage error encodes the data in accordance with a dispersed storage error encoding process based on dispersed storage error encoding parameters. The dispersed storage error encoding parameters include an encoding function (e.g., information dispersal algorithm, Reed-Solomon, Cauchy Reed-Solomon, systematic encoding, non-systematic encoding, on-line codes, etc.), a data segmenting protocol (e.g., data segment size, fixed, variable, etc.), and per data segment encoding values. The per data segment encoding values include a total, or pillar width, number (T) of encoded data slices per encoding of a data segment (i.e., in a set of encoded data slices); a decode threshold number (D) of encoded data slices of a set of encoded data slices that are needed to recover the data segment; a read threshold number (R) of encoded data slices to indicate a number of encoded data slices per set to be read from storage for decoding of the data segment; and/or a write threshold number (W) to indicate a number of encoded data slices per set that must be accurately stored before the encoded data segment is deemed to have been properly stored. The dispersed storage error encoding parameters may further include slicing information (e.g., the number of encoded data slices that will be created for each data segment) and/or slice security information (e.g., per encoded data slice encryption, compression, integrity checksum, etc.).

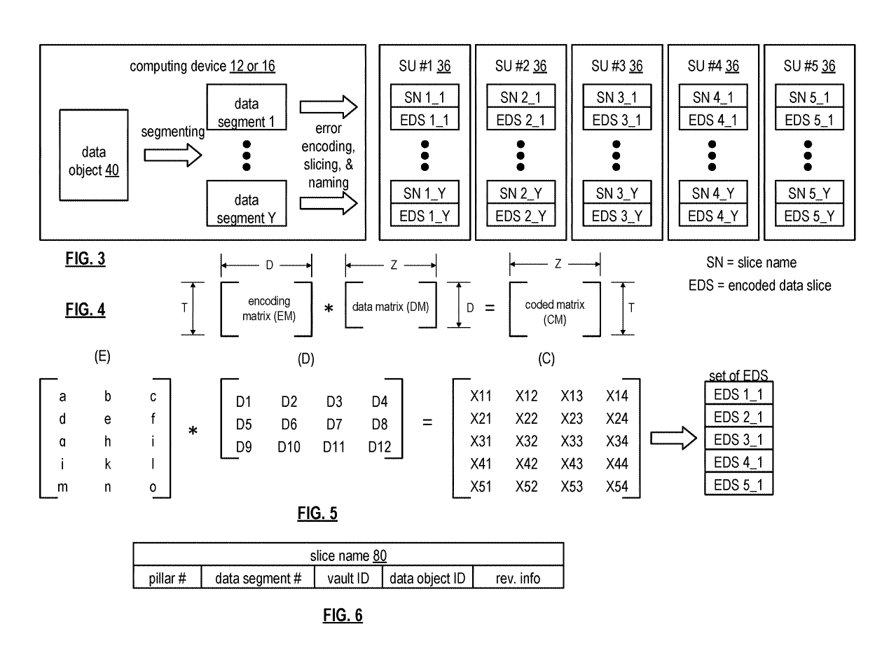

In the present example, Cauchy Reed-Solomon has been selected as the encoding function (a generic example is shown in FIG. 4 and a specific example is shown in FIG. 5); the data segmenting protocol is to divide the data object into fixed sized data segments; and the per data segment encoding values include: a pillar width of 5, a decode threshold of 3, a read threshold of 4, and a write threshold of 4. In accordance with the data segmenting protocol, the computing device 12 or 16 divides the data (e.g., a file (e.g., text, video, audio, etc.), a data object, or other data arrangement) into a plurality of fixed sized data segments (e.g., 1 through Y of a fixed size in range of Kilo-bytes to Tera-bytes or more). The number of data segments created is dependent of the size of the data and the data segmenting protocol.

The computing device 12 or 16 then disperse storage error encodes a data segment using the selected encoding function (e.g., Cauchy Reed-Solomon) to produce a set of encoded data slices. FIG. 4 illustrates a generic Cauchy Reed-Solomon encoding function, which includes an encoding matrix (EM), a data matrix (DM), and a coded matrix (CM). The size of the encoding matrix (EM) is dependent on the pillar width number (T) and the decode threshold number (D) of selected per data segment encoding values. To produce the data matrix (DM), the data segment is divided into a plurality of data blocks and the data blocks are arranged into D number of rows with Z data blocks per row. Note that Z is a function of the number of data blocks created from the data segment and the decode threshold number (D). The coded matrix is produced by matrix multiplying the data matrix by the encoding matrix.

FIG. 5 illustrates a specific example of Cauchy Reed-Solomon encoding with a pillar number (T) of five and decode threshold number of three. In this example, a first data segment is divided into twelve data blocks (D1-D12). The coded matrix includes five rows of coded data blocks, where the first row of X11-X14 corresponds to a first encoded data slice (EDS 1_1), the second row of X21-X24 corresponds to a second encoded data slice (EDS 2_1), the third row of X31-X34 corresponds to a third encoded data slice (EDS 3_1), the fourth row of X41-X44 corresponds to a fourth encoded data slice (EDS 4_1), and the fifth row of X51-X54 corresponds to a fifth encoded data slice (EDS 5_1). Note that the second number of the EDS designation corresponds to the data segment number.

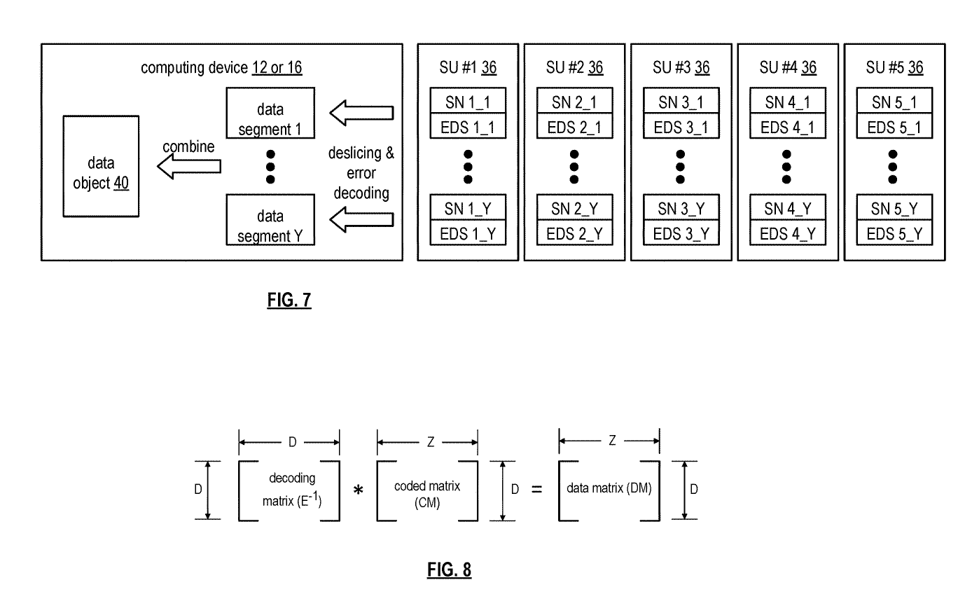

Returning to the discussion of FIG. 3, the computing device also creates a slice name (SN) for each encoded data slice (EDS) in the set of encoded data slices. A typical format for a slice name 80 is shown in FIG. 6. As shown, the slice name (SN) 80 includes a pillar number of the encoded data slice (e.g., one of 1-T), a data segment number (e.g., one of 1-Y), a vault identifier (ID), a data object identifier (ID), and may further include revision level information of the encoded data slices. The slice name functions as, at least part of, a DSN address for the encoded data slice for storage and retrieval from the DSN memory 22.

As a result of encoding, the computing device 12 or 16 produces a plurality of sets of encoded data slices, which are provided with their respective slice names to the storage units for storage. As shown, the first set of encoded data slices includes EDS 1_1 through EDS 5_1 and the first set of slice names includes SN 1_1 through SN 5_1 and the last set of encoded data slices includes EDS 1_Y through EDS 5_Y and the last set of slice names includes SN 1_Y through SN 5_Y.

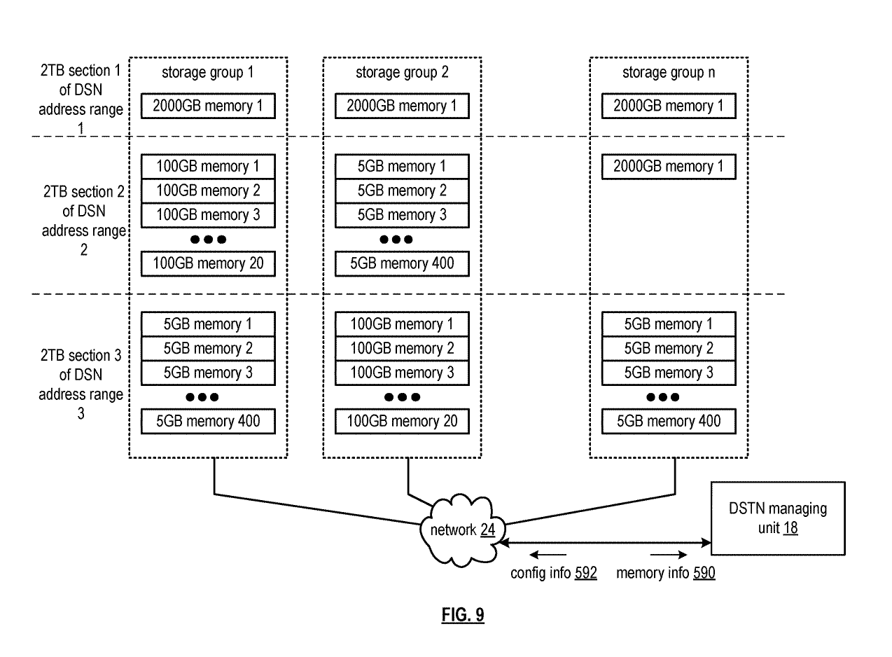

FIG. 7 is a schematic block diagram of an example of dispersed storage error decoding of a data object that was dispersed storage error encoded and stored in the example of FIG. 4. In this example, the computing device 12 or 16 retrieves from the storage units at least the decode threshold number of encoded data slices per data segment. As a specific example, the computing device retrieves a read threshold number of encoded data slices.

To recover a data segment from a decode threshold number of encoded data slices, the computing device uses a decoding function as shown in FIG. 8. As shown, the decoding function is essentially an inverse of the encoding function of FIG. 4. The coded matrix includes a decode threshold number of rows (e.g., three in this example) and the decoding matrix in an inversion of the encoding matrix that includes the corresponding rows of the coded matrix. For example, if the coded matrix includes rows 1, 2, and 4, the encoding matrix is reduced to rows 1, 2, and 4, and then inverted to produce the decoding matrix.

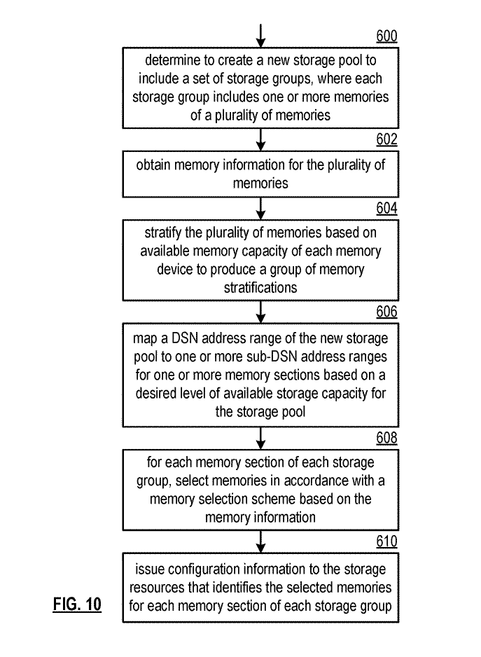

Referring next to FIGS. 9 and 10, various devices, systems, and techniques that can be used to group memory units in an ad-hoc and heterogeneous network to maximize failure independence are discussed. In ad hoc DSN memories composed of DS units operating from heterogeneous devices, networks, and locations, and supporting varying capacities, the process for assigning which groups of DS units to place into the same storage pool and allocating namespace assignments may operate as follows:

1. Establish a width number of “buckets.”

2. Determine an approximate “Least Common Multiple” (LCM) of the storage capacities for each of the various types of devices to be assigned.

3. Place groups of related and similar devices into the same bucket, and place enough devices into each bucket to just exceed the LCM amount of storage. For example, in at least one embodiment, with devices of capacities 5 GB, 100 GB, and 2 TB, the LCM is 2 TB. In buckets composed of the 5 GB capacity devices, there will be 400 devices added, for the buckets containing the 100 GB devices, there will be 20 devices added, and for buckets containing 2 TB devices, there will be 1 device added.

4. Attempt to allocate each bucket's storage using a different device type, and also to, where possible, use devices from different locations, and different networks/network providers.

5. Use each bucket to service all access of slices of the same information dispersal algorithm (IDA) index (e.g. the same pillar), and then apportion namespace assignments to each device in proportion to the storage capacity of each device. For example, in some embodiments, the range of the 5 GB devices will be 1/400th the size of the range assigned to the 2 TB devices. Given a sufficient number of devices, the end result will be a storage pool such that every pillar is composed of a different kind of device, with possibly unique hardware and software, and with devices operating out of distinct locations. Moreover, this approach enables ds units having vastly different storage capacities to operate within a single storage pool. It can also be immune to, or at least less affected by, network outages of single providers (e.g. the local cable company, a particular cell phone tower, an OS patch that bricks devices, etc.).

FIG. 9 is a schematic block diagram of another embodiment of a dispersed storage network (DSN) that includes a set of storage groups 1-n, the network 24 of FIG. 1, and a DSTN managing unit 18 of FIG. 1. Each storage group includes one or more sections, where each section includes one or more memories. Each memory may include one or more of a storage unit, a user device, a distributed storage and task (DST) processing unit, and a memory device. The DSN functions to select memories to form a storage pool that includes the set of storage groups 1-n.

In an example of operation of the selecting of the memories, the DSTN managing unit 18 of FIG. 1 determines to create the storage pool to include the set of storage groups 1-n, where a number of storage groups of the set of storage groups is based on an information dispersal algorithm (IDA) width n, and where each storage group includes one or more memories such that each storage group includes substantially a same available storage capacity, and where a DSN address range (e.g., start and end source names, a slice name range) is associated with the set of storage groups. The determining includes at least one of receiving a request, interpreting a configuration command, and detecting insufficient storage capacity for an existing storage pool.

Having determined to create the storage pool, the DSTN managing unit 18 of FIG. 1 obtains memory information 590 for a plurality of memories of the DSN, where the memory information 590 includes, for each memory, one or more of a maximum capacity availability level, a currently available capacity level, and a memory profile (e.g., a memory type, a manufacturer, a software version, a physical location of implementation, and network connectivity configuration information). The obtaining includes at least one of interpreting a query response, interpreting system registry information, and receiving the memory information.

Having obtained the memory information 590, the DSTN managing unit 18 of FIG. 1 stratifies a plurality of memories based on available memory capacity of each memory to produce a group of memory stratifications. The stratifying includes one or more of determining available capacity for each memory device and grouping identifiers of member devices associated with similar memory capacities together in a common memory stratification.

Having stratified the memories, the DSTN managing unit 18 of FIG. 1 maps the DSN address range to one or more sub-DSN address ranges for one or more memory sections based on a desired level of available storage capacity. For example, the DSTN managing unit identifies a larger size memory stratification (e.g., 2 TB), divides the desired available capacity for each storage group by the largest size memory stratification to produce a number of sub-DSN address ranges (e.g., 3), and divides the DSN address range into the number of sub-DSN address ranges.

Having mapped the DSN address range, for each memory section across each storage group, the DSTN managing unit 18 of FIG. 1 selects memories in accordance with a number selection scheme (e.g., maximizing diversity between groups) based on the memory information such that the memory section includes available capacity substantially the same as the largest size memory stratification. Examples of maximizing diversity includes utilizing different memory types between storage groups, utilizing memories implemented at different sites amongst the different storage groups, etc.

Having selected the memories, the DSTN managing unit 18 of FIG. 1 issues configuration information 592 to storage resources (e.g., storage unit, user device, etc.) of the DSN that includes identifiers of the selected memories for each memory section of each storage group, and associated sub-DSN address range, and a portion of the sub-DSN address range allocated to each memory. For example, the DSTN managing unit 18 of FIG. 1 generates a portion of the sub-DSN address range for each memory, generates the configuration information message to include a memory identifier of a memory, the portion of the sub-DSN address range allocated to the memory, and the storage group identifier, and sends, via the network 24 of FIG. 1, the configuration information 592 to the storage resources to facilitate assignments of the memories to the storage pool.

FIG. 10 is a flowchart illustrating an example of selecting memories to form a storage pool. The method includes block 600 where a processing module (e.g., of a distributed storage and task network (DSTN) managing unit) determines to create a new storage pool to include a set of storage groups, where each storage group includes one or more memories of a plurality of memories. The determining includes one or more of receiving a request, interpreting a configuration command, and detecting insufficient storage capacity for an existing storage pool.

The method continues at block 602 where the processing module obtains memory information for the plurality of memories. The obtaining includes at least one of interpreting a query response and interpreting system registry information. The method continues at block 604 where the processing module stratifies the plurality of memories based on available memory capacity of each memory device to produce a group of memory stratifications. For example, the processing module determines available capacity of each memory device from the memory information, and groups memory devices associated with similar memory capacities together into a common memory stratification.

The method continues at block 606 where the processing module maps a DSN address range of the new storage pool to one or more sub-DSN address ranges for one or more memory sections based on a desired level of available storage capacity for the storage pool. For example, the processing module identifies a larger size memory stratification, provides a desired available capacity for each storage group by the largest size memory stratification to produce a number of sub-DSN address ranges, and divides the DSN address range into the number of sub-DSN address ranges.

For each memory section of each storage group, the method continues at block 608 where the processing module selects memories in accordance with a memory selection scheme based on the memory information. For example, the processing module chooses memories (e.g., to maximize diversity between storage groups, based on the memory information such that the memory section includes available capacity substantially the same as the large-size memory stratification.

The method continues at block 610 where the processing module issues configuration information to the storage resources that identifies the selected memories for each memory section of each storage group. For example, the processing module generates the portion of the sub-DSN address range for each memory, generates the configuration information message to include a memory identifier of a memory, a portion of the sub-DSN address range allocated to the memory, and the storage group identifier, and further sends the configuration information to the storage resources.

It is noted that terminologies as may be used herein such as bit stream, stream, signal sequence, etc. (or their equivalents) have been used interchangeably to describe digital information whose content corresponds to any of a number of desired types (e.g., data, video, speech, audio, etc. any of which may generally be referred to as ‘data’).

As may be used herein, the terms “substantially” and “approximately” provides an industry-accepted tolerance for its corresponding term and/or relativity between items. Such an industry-accepted tolerance ranges from less than one percent to fifty percent and corresponds to, but is not limited to, component values, integrated circuit process variations, temperature variations, rise and fall times, and/or thermal noise. Such relativity between items ranges from a difference of a few percent to magnitude differences. As may also be used herein, the term(s) “configured to”, “operably coupled to”, “coupled to”, and/or “coupling” includes direct coupling between items and/or indirect coupling between items via an intervening item (e.g., an item includes, but is not limited to, a component, an element, a circuit, and/or a module) where, for an example of indirect coupling, the intervening item does not modify the information of a signal but may adjust its current level, voltage level, and/or power level. As may further be used herein, inferred coupling (i.e., where one element is coupled to another element by inference) includes direct and indirect coupling between two items in the same manner as “coupled to”. As may even further be used herein, the term “configured to”, “operable to”, “coupled to”, or “operably coupled to” indicates that an item includes one or more of power connections, input(s), output(s), etc., to perform, when activated, one or more its corresponding functions and may further include inferred coupling to one or more other items. As may still further be used herein, the term “associated with”, includes direct and/or indirect coupling of separate items and/or one item being embedded within another item.

As may be used herein, the term “compares favorably”, indicates that a comparison between two or more items, signals, etc., provides a desired relationship. For example, when the desired relationship is that signal 1 has a greater magnitude than signal 2, a favorable comparison may be achieved when the magnitude of signal 1 is greater than that of signal 2 or when the magnitude of signal 2 is less than that of signal 1. As may be used herein, the term “compares unfavorably”, indicates that a comparison between two or more items, signals, etc., fails to provide the desired relationship.

As may also be used herein, the terms “processing module”, “processing circuit”, “processor”, and/or “processing unit” may be a single processing device or a plurality of processing devices. Such a processing device may be a microprocessor, micro-controller, digital signal processor, microcomputer, central processing unit, field programmable gate array, programmable logic device, state machine, logic circuitry, analog circuitry, digital circuitry, and/or any device that manipulates signals (analog and/or digital) based on hard coding of the circuitry and/or operational instructions. The processing module, module, processing circuit, and/or processing unit may be, or further include, memory and/or an integrated memory element, which may be a single memory device, a plurality of memory devices, and/or embedded circuitry of another processing module, module, processing circuit, and/or processing unit. Such a memory device may be a read-only memory, random access memory, volatile memory, non-volatile memory, static memory, dynamic memory, flash memory, cache memory, and/or any device that stores digital information. Note that if the processing module, module, processing circuit, and/or processing unit includes more than one processing device, the processing devices may be centrally located (e.g., directly coupled together via a wired and/or wireless bus structure) or may be distributedly located (e.g., cloud computing via indirect coupling via a local area network and/or a wide area network). Further note that if the processing module, module, processing circuit, and/or processing unit implements one or more of its functions via a state machine, analog circuitry, digital circuitry, and/or logic circuitry, the memory and/or memory element storing the corresponding operational instructions may be embedded within, or external to, the circuitry comprising the state machine, analog circuitry, digital circuitry, and/or logic circuitry. Still further note that, the memory element may store, and the processing module, module, processing circuit, and/or processing unit executes, hard coded and/or operational instructions corresponding to at least some of the steps and/or functions illustrated in one or more of the Figures. Such a memory device or memory element can be included in an article of manufacture.

One or more embodiments have been described above with the aid of method steps illustrating the performance of specified functions and relationships thereof. The boundaries and sequence of these functional building blocks and method steps have been arbitrarily defined herein for convenience of description. Alternate boundaries and sequences can be defined so long as the specified functions and relationships are appropriately performed. Any such alternate boundaries or sequences are thus within the scope and spirit of the claims. Further, the boundaries of these functional building blocks have been arbitrarily defined for convenience of description. Alternate boundaries could be defined as long as the certain significant functions are appropriately performed. Similarly, flow diagram blocks may also have been arbitrarily defined herein to illustrate certain significant functionality.

To the extent used, the flow diagram block boundaries and sequence could have been defined otherwise and still perform the certain significant functionality. Such alternate definitions of both functional building blocks and flow diagram blocks and sequences are thus within the scope and spirit of the claims. One of average skill in the art will also recognize that the functional building blocks, and other illustrative blocks, modules and components herein, can be implemented as illustrated or by discrete components, application specific integrated circuits, processors executing appropriate software and the like or any combination thereof.

In addition, a flow diagram may include a “start” and/or “continue” indication. The “start” and “continue” indications reflect that the steps presented can optionally be incorporated in or otherwise used in conjunction with other routines. In this context, “start” indicates the beginning of the first step presented and may be preceded by other activities not specifically shown. Further, the “continue” indication reflects that the steps presented may be performed multiple times and/or may be succeeded by other activities not specifically shown. Further, while a flow diagram indicates a particular ordering of steps, other orderings are likewise possible provided that the principles of causality are maintained.

The one or more embodiments are used herein to illustrate one or more aspects, one or more features, one or more concepts, and/or one or more examples. A physical embodiment of an apparatus, an article of manufacture, a machine, and/or of a process may include one or more of the aspects, features, concepts, examples, etc. described with reference to one or more of the embodiments discussed herein. Further, from figure to figure, the embodiments may incorporate the same or similarly named functions, steps, modules, etc. that may use the same or different reference numbers and, as such, the functions, steps, modules, etc. may be the same or similar functions, steps, modules, etc. or different ones.

Unless specifically stated to the contra, signals to, from, and/or between elements in a figure of any of the figures presented herein may be analog or digital, continuous time or discrete time, and single-ended or differential. For instance, if a signal path is shown as a single-ended path, it also represents a differential signal path. Similarly, if a signal path is shown as a differential path, it also represents a single-ended signal path. While one or more particular architectures are described herein, other architectures can likewise be implemented that use one or more data buses not expressly shown, direct connectivity between elements, and/or indirect coupling between other elements as recognized by one of average skill in the art.

The term “module” is used in the description of one or more of the embodiments. A module implements one or more functions via a device such as a processor or other processing device or other hardware that may include or operate in association with a memory that stores operational instructions. A module may operate independently and/or in conjunction with software and/or firmware. As also used herein, a module may contain one or more sub-modules, each of which may be one or more modules.

As may further be used herein, a computer readable memory includes one or more memory elements. A memory element may be a separate memory device, multiple memory devices, or a set of memory locations within a memory device. Such a memory device may be a read-only memory, random access memory, volatile memory, non-volatile memory, static memory, dynamic memory, flash memory, cache memory, and/or any device that stores digital information. The memory device may be in a form a solid state memory, a hard drive memory, cloud memory, thumb drive, server memory, computing device memory, and/or other physical medium for storing digital information.

While particular combinations of various functions and features of the one or more embodiments have been expressly described herein, other combinations of these features and functions are likewise possible. The present disclosure is not limited by the particular examples disclosed herein and expressly incorporates these other combinations.

What is claimed is:

1. A method for use in a distributed storage network (DSN) including a plurality of distributed storage (DS) units, the method comprising:
determining to create a new storage pool to include a set of storage groups, where storage groups included in the set of storage groups include one or more memory sections, and the one or more memory sections include one or more DS units of the plurality of DS units;
obtaining memory information associated with the plurality of DS units;
stratifying the plurality of DS units based on available memory capacity to produce a group of memory stratifications;
mapping a DSN address range of the new storage pool to one or more sub-DSN address ranges for the one or more memory sections based on a level of available storage capacity of the new storage pool;
for each of the one or more memory sections, selecting particular DS units of the plurality of DS units as selected DS units, the selecting performed in accordance with a memory selection scheme based on the memory information; and
issuing configuration information to the plurality of DS units, the configuration information identifying the selected DS units for inclusion in particular memory sections of particular storage groups.

2. The method of claim 1, wherein:
the memory information includes one or more items from the group consisting of: a maximum capacity availability level, a currently available capacity level, and a memory profile; and wherein
stratifying includes:
determining available capacity of each memory device based at least in part on the memory information; and.
grouping together similar memory capacity memory devices in a common memory stratification.

3. The method of claim 2, wherein:
the memory profile includes one or more items selected from the group consisting of: a memory type, a manufacturer, a software version, a physical location of the DS unit, and network connectivity configuration information; and wherein
the memory selection scheme is configured to choose DS units for inclusion based, at least in part, on the DS units having diverse characteristics according to memory profiles associated with particular DS units.

4. The method of claim 1, wherein mapping a DSN address range of the new storage pool further comprises:
identifying a largest-size memory stratification;
dividing an available capacity associated with each storage group by the largest-size memory stratification to produce a number of sub-DSN address ranges; and
dividing the DSN address range into the number of sub-DSN address ranges.

5. The method of claim 4, wherein selecting particular DS units includes:
choose DS units based so that available capacity of the selected DS units is substantially the same as the largest-size memory stratification.

6. The method of claim 1, further comprising:
establishing a number of memory sections corresponding to a dispersed encoding pillar width;
determining an approximate least-common-multiple (LCM) amount of storage capacity of the DS units based, at least in part on the memory information; and
placing a sufficient number of DS units into the number of memory sections to just exceed the LCM amount of storage capacity.

7. The method of claim 6, further comprising:
attempting to allocate storage associated with each of the number of memory sections to DS units having diverse device characteristics, physical locations, and networks;
using each memory section to service all access of slices of the same dispersed encoding pillar; and
apportioning namespace assignments to each of the DS units in proportion to a storage capacity of each DS unit.

8. A managing unit for use in a distributed storage network (DSN) including a plurality of distributed storage (DS) units, the managing unit comprising:
at least one computing core including a processing module and a memory;
a program of instructions configured to be stored in the memory and executed by the processing module, the program of instructions including:
at least one instruction to determine to create a new storage pool to include a set of storage groups, where storage groups included in the set of storage groups include one or more memory sections, and the one or more memory sections include one or more DS units of the plurality of DS units;
at least one instruction to obtain memory information associated with the plurality of DS units;
at least one instruction to stratify the plurality of DS units based on available memory capacity to produce a group of memory stratifications;
at least one instruction to map a DSN address range of the new storage pool to one or more sub-DSN address ranges for the one or more memory sections based on a level of available storage capacity of the new storage pool;
at least one instruction to select, for each of the one or more memory sections, particular DS units of the plurality of DS units as selected DS units, wherein the at least one instruction to select is configured to be identify the selected DS units in accordance with a memory selection scheme based on the memory information; and
at least one instruction to issue configuration information to the plurality of DS units, the configuration information identifying the selected DS units for inclusion in particular memory sections of particular storage groups.

9. The managing unit of claim 8, wherein:
the memory information includes one or more items from the group consisting of: a maximum capacity availability level, a currently available capacity level, and a memory profile; and wherein
the at least one instruction to stratify includes:
at least one instruction to determine available capacity of each memory device based at least in part on the memory information; and
at least one instruction to group together similar memory capacity memory devices in a common memory stratification.

10. The managing unit of claim 9, wherein:
the memory profile includes one or more items selected from the group consisting of: a memory type, a manufacturer, a software version, a physical location of the DS unit, and network connectivity configuration information; and wherein
the memory selection scheme is configured to choose DS units for inclusion based, at least in part, on the DS units having diverse characteristics according to memory profiles associated with particular DS units.

11. The managing unit of claim 8, wherein the at least one instruction to map a DSN address range of the new storage pool further comprises:
at least one instruction to identify a largest-size memory stratification;
at least one instruction to divide an available capacity associated with each storage group by the largest-size memory stratification to produce a number of sub-DSN address ranges; and
at least one instruction to divide the DSN address range into the number of sub-DSN address ranges.

12. The managing unit of claim 11, wherein the at least one instruction to select particular DS units includes:
at least one instruction to choose DS units based so that available capacity of the selected DS units is substantially the same as the largest-size memory stratification.

13. The managing unit of claim 8, wherein the program of instructions further comprises:
at least one instruction to establish a number of memory sections corresponding to a dispersed encoding pillar width;
at least one instruction to determine an approximate least-common-multiple (LCM) amount of storage capacity of the DS units based, at least in part on the memory information; and
at least one instruction to placing a sufficient number of DS units into the number of memory sections to just exceed the LCM amount of storage capacity.

14. The managing unit of claim 13, wherein the program of instructions further comprises:
at least one instruction to attempt to allocate storage associated with each of the number of memory sections to DS units having diverse device characteristics, physical locations, and networks;
at least one instruction to use each memory section to service access to slices of the same dispersed encoding pillar; and
at least one instruction to apportion namespace assignments to each of the plurality of DS units in proportion to a storage capacity of each DS Unit.

15. A distributed storage network (DSN) comprising:
one or more DSN memories including a plurality of distributed storage (DS) units, the one or more DSN memories configured to store data slices generated in accordance with an information dispersal algorithm;
a managing unit including:
at least one computing core including a processing module and a memory;
a program of instructions configured to be stored in the memory and executed by the processing module, the program of instructions including:
at least one instruction to determine to create a new storage pool to include a set of storage groups, where storage groups included in the set of storage groups include one or more memory sections, and the one or more memory sections include one or more DS units of the plurality of DS units;
at least one instruction to obtain memory information associated with the plurality of DS units;
at least one instruction to stratify the plurality of DS units based on available memory capacity to produce a group of memory stratifications;
at least one instruction to map a DSN address range of the new storage pool to one or more sub-DSN address ranges for the one or more memory sections based on a level of available storage capacity of the new storage pool;
at least one instruction to select, for each of the one or more memory sections, particular DS units of the plurality of DS units as selected DS units, wherein the at least one instruction to select is configured to be identify the selected DS units in accordance with a memory selection scheme based on the memory information; and
at least one instruction to issue configuration information to the plurality of DS units, the configuration information identifying the selected DS units for inclusion in particular memory sections of particular storage groups.

16. The distributed storage network (DSN) of claim 15, wherein:
the memory information includes one or more items from the group consisting of: a maximum capacity availability level, a currently available capacity level, and a memory profile; and wherein
the at least one instruction to stratify includes:
at least one instruction to determine available capacity of each memory device based at least in part on the memory information; and
at least one instruction to group together similar memory capacity memory devices in a common memory stratification.

17. The distributed storage network (DSN) of claim 16, wherein:
the memory profile includes one or more items selected from the group consisting of: a memory type, a manufacturer, a software version, a physical location of the DS unit, and network connectivity configuration information; and wherein
the memory selection scheme is configured to choose DS units for inclusion based, at least in part, on the DS units having diverse characteristics according to memory profiles associated with particular DS units.

18. The distributed storage network (DSN) of claim 15, wherein the at least one instruction to map a DSN address range of the new storage pool further comprises:
at least one instruction to identify a largest-size memory stratification;
at least one instruction to divide an available capacity associated with each storage group by the largest-size memory stratification to produce a number of sub-DSN address ranges; and
at least one instruction to divide the DSN address range into the number of sub-DSN address ranges.

19. The distributed storage network (DSN) of claim 18, wherein the at least one instruction to select particular DS units includes:
at least one instruction to choose DS units based so that available capacity of the selected DS units is substantially the same as the largest-size memory stratification.

20. The distributed storage network (DSN) of claim 15, wherein the program of instructions further comprises:
at least one instruction to establish a number of memory sections corresponding to a dispersed encoding pillar width;
at least one instruction to determine an approximate least-common-multiple (LCM) amount of storage capacity of the DS units based, at least in part on the memory information; and
at least one instruction to placing a sufficient number of DS units into the number of memory sections to just exceed the LCM amount of storage capacity.
